(19) United States
(12) Patent Application Publication
(10) Pub. No.: US 2026/0040048 A1
(43) Pub. Date: Feb. 5, 2026

(54) SYSTEM AND METHODS FOR EMERGENCY TEXT MESSAGE TRANSMISSION

(71) Applicant: T-MOBILE INNOVATIONS LLC, Overland Park, KS (US)

(72) Inventor: Hang Hoi YAU, Sammamish, WA (US)

(21) Appl. No.: 18/790,018

(22) Filed: Jul. 31, 2024

(51) Int. Cl. H04W 4/90; H04M 11/04; H04W 4/14

(52) U.S. Cl. CPC H04W 4/90; H04M 11/04; H04W 4/14

(57) ABSTRACT

Systems, methods and devices are provided for transmitting, by a wireless device, a call request to a public safety answering point (PSAP) using a wireless network, determining a connection status of the call request based on the wireless network and, in response to the connection status being termination by the wireless network, transmitting a text message to the PSAP using the wireless network.

### TECHNICAL BACKGROUND

In case of emergencies, cellular phones, such as smartphones, are often used for contacting emergency services. The primary mode of contacting emergency services is usually by placing a phone call to emergency operations, such as 911 dispatch operators. Although those emergency calls are prioritized by wireless network, in some cases the call might not go through. For example, due to an issue with the user device or the network. In those situations, the person in need of emergency assistance might not be able to contact emergency services in a timely manner, which may lead to a catastrophic situation of a person being left to her or his own devices without any help on the way.

### Overview

Exemplary embodiments described herein include systems, methods, and processing nodes for emergency text message transmission. An exemplary method includes transmitting, by a wireless device, a call request to a public safety answering point (PSAP) using a wireless network. Based on the transmission to the wireless network, the method includes determining a connection status of the call request. The method further includes, in response to the connection status being termination by the wireless network, transmitting a text message to the PSAP using the wireless network.

Further exemplary embodiments include a system for emergency text message transmission. The system includes a wireless network. The system additionally includes a computing device including a processor configured to transmit a call request to a PSAP using the wireless network. The processor is further configured to determine connection status of the call request based on the wireless network and, in response to the connection status being termination by the wireless network, transmit a text message to the PSAP using the wireless network.

In yet a further exemplary embodiment, a non-transitory computer readable medium is provided. The non-transitory computer-readable medium stores instructions, when executed by a processor, configuring the processor to transmit a call request to a PSAP using a wireless network, determine a connection status of the call request based on the wireless network, and, in response to the connection status being termination by the wireless network, transmit a text message to the PSAP using the wireless network.

### BRIEF DESCRIPTION OF THE DRAWINGS

FIG. 1 illustrates an exemplary system for text communication in accordance with disclosed embodiments.

FIG. 2 illustrates an additional exemplary system for SMS emergency communication in accordance with disclosed embodiments.

FIG. 3 illustrates an exemplary decision chart for SMS emergency transmission in accordance with disclosed embodiments.

FIG. 4 illustrates an exemplary method for text message emergency contact in accordance with disclosed embodiments.

FIG. 5 illustrates an example of a computing device in accordance with aspects of this disclosure.

FIG. 6 illustrates an example of a processing node in accordance with aspects of this disclosure.

### DETAILED DESCRIPTION

In situations where a wireless network may be having issues, which render the wireless network unable to complete a call requested by a wireless device, the wireless network may still be able to forward text messages, such as short message service (SMS) messages, to emergency services containing basic identifying information, such as an assigned phone number for the wireless device, which may enable the emergency services to attempt to contact and locate the wireless device. In some instances, the data layer may be available for communication while the voice call layer of the network is unavailable. In addition, a text message uses less network resources than a voice call and may be more available in an emergency.

Many modern public safety answering points (PSAPs) are capable of receiving a plurality of media, such as SMS messages. For example, a PSAP may have a Next Gen 911 system implemented, which can handle multiple media types.

Exemplary embodiments described herein include systems and methods for transmitting a text message to an emergency service, e.g., a PSAP, when an emergency call fails. For example, after a certain amount of time trying to complete a call to 911 without a response or when the call is terminated by a wireless network, a smart phone, or any device configured to use SMS, may send an SMS message to the emergency service.

This action does not preclude a person experiencing an emergency from continuing to try calling the emergency service using the wireless device, but it allows the emergency service to be notified that an emergency associated with that wireless device is occurring. For example, the emergency service after receiving a text message, such as an SMS message, with a wireless device phone number, may be able to locate the wireless device or attempt to contact the person associated with that wireless device. On some occasions, the wireless device may not be able to complete the call due to an unknown issue, but it may be able to still receive a call.

The emergency may be an emergency event including a combination of multiple types of events, such as, for example active shooting scenarios, natural disasters, vehicle collisions, crashes, and/or other road blockages, plane crashes.

Given the importance that text messages only be transmitted in case of an emergency, the methods and system herein do not generate the text message when the call is terminated on the caller's end. For example, a caller may have dialed 911 by accident and hangs up as soon as the mistake is noticed. In those situations, it is important to discern between emergencies and non-emergencies, especially since the text message will often not provide context aside from information enabling the caller to be identified.

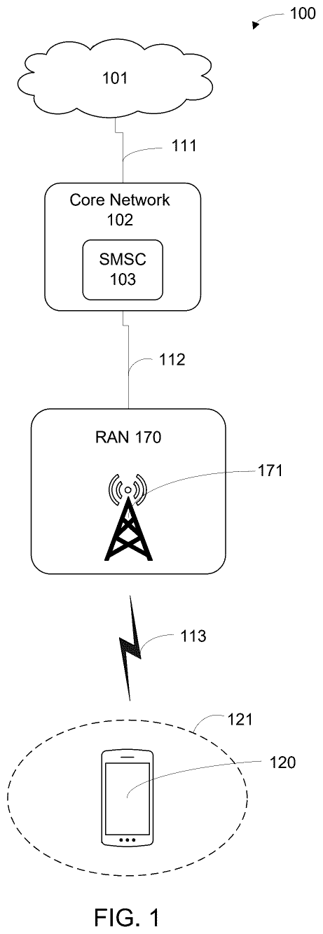

These and other examples will be described in greater detail below in relation to FIGS. 1-6.

FIG. 1 depicts an exemplary system 100 for text based communication. System 100 includes a communication network 101, a core network 102 and a radio access network (RAN) 170, including at least one access node 171.

Core network 102 is connected to communication network 101 over communication link 111. Core network 102 includes a short message service center (SMSC) 103. SMSC 103 as used herein is an SMS management component used for storing, forwarding and delivering SMS messages. It should be noted that only SMSC 103 is described for ease of description, and that core network 102 may further include other components used for handling text messages, such as a multimedia messaging service center (MMSC), IP multimedia subsystems (IMS), rich communication services (RCS) serves, and the like.

The RAN 170 may include other devices and additional nodes not described herein. For example, RAN 170 may include devices used for forwarding SMS messages from wireless device 120 to core network 102. RAN 170 is connected to core network 102 over communication link 112.

System 100 also includes a wireless device 120. In embodiments, system 100 may include multiple wireless devices. Wireless device 120 is configured to operate in one or more coverage areas 121. Wireless device 120 may be an end-user wireless device. Wireless device 120 may include any device configured to send and receive text messages. In embodiments, wireless device 120 communicates with RAN 170 over communication link 113. Examples of communication link 113 may include 5G network, 4G LTE, and the like.

Communication network 101 may be wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless device 120. Wireless network protocols can include multimedia broadcast multicast service (MBMS), code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE), 6G and/or non-terrestrial networks. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may have an evolved packet core (EPC) or may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM function provides services to other core functions, such as the AMF, SMF, and NEF. The UDM may function as a stateful message store, holding information in local memory. The NSSF can be used by the AMF to assist with the selection of network slice instances that will serve a particular device. Further, the NEF provides a mechanism for securely exposing services and features of the core network.

Although one core network 102 is shown, multiple core networks 102 may be utilized. Alternatively, the single core network 102 may include a distributed, cloud-native, converged core gateway. Thus, the converged core gateway could connect a 4G LTE evolved packet core (EPC) to a 5G core network.

Communication links 111 and 112 can use various communication media, such as air, space, metal, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

In embodiments, RAN 170 may include various access network systems and devices such as access node 171. The RAN 170 is disposed between the core network 102 and the end-user wireless device 120. Components of the RAN 170 may communicate directly with the core network 102 and others may communicate directly with the end user wireless device 120. The RAN 170 may provide services from the core network 102 to the end-user wireless device 120.

The RAN 170 includes at least an access node (or base station) 171 such as an eNodeB or gNodeB communicating with the one or more end-user wireless devices 120. It is understood that the disclosed technology may also be applied to communication between an end-user wireless device and other network resources, such as relay nodes, controller nodes, antennas, etc. Further, multiple access nodes may be utilized. For example, some wireless devices may communicate with an LTE eNodeB and others may communicate with an NR gNodeB.

Access node 171 can be, for example, standard access nodes such as a macro-cell access node, a base transceiver station, a radio base station, an eNodeB device, an enhanced eNodeB device, a gNodeB in 5G New Radio (“5G NR”), or the like. The gNBs may include, for example, centralized units (CUs) and distributed units (DUs).

In additional embodiments, access nodes may comprise two co-located cells, or antenna/transceiver combinations that are mounted on the same structure. Alternatively, access node 171 may comprise a short range, low power, small-cell access node such as a microcell access node, a picocell access node, a femtocell access node, or a home eNodeB device. As will be further described below, functionality for emergency navigational pathing may be included within the access nodes. Access node 171 can be configured to deploy one or more different carriers, utilizing one or more RATs. For example, a gNodeB may support NR and an eNodeB may provide LTE coverage. It would be evident to one of ordinary skill in the art, in light of this disclosure, the many other combinations of access nodes and carriers that could be deployed.

The access node 171 may include a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless device 120 may include any wireless device included in a wireless network. For example, the term “wireless device” may include a relay node, which may communicate with an access node. The term “wireless device” may also include an end-user wireless device, which may communicate with the access node 171 through the relay node. The term “wireless device” may further include an end-user wireless device that communicates with the access node 171 directly without being relayed by a relay node.

Wireless device 120 may be any device, system, combination of devices, or other such communication platform capable of communicating wirelessly with access network 171 using one or more frequency bands and wireless carriers deployed therefrom. Each of wireless devices 120, may be, for example, a mobile phone, a wireless phone, a wireless modem, a personal digital assistant (PDA), a voice over internet protocol (VoIP) phone, a voice over packet (VOP) phone, or a soft phone, an internet of things (loT) device, as well as other types of devices or systems that can send and receive audio or data. The wireless device 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless device 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for emergency text message connection may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

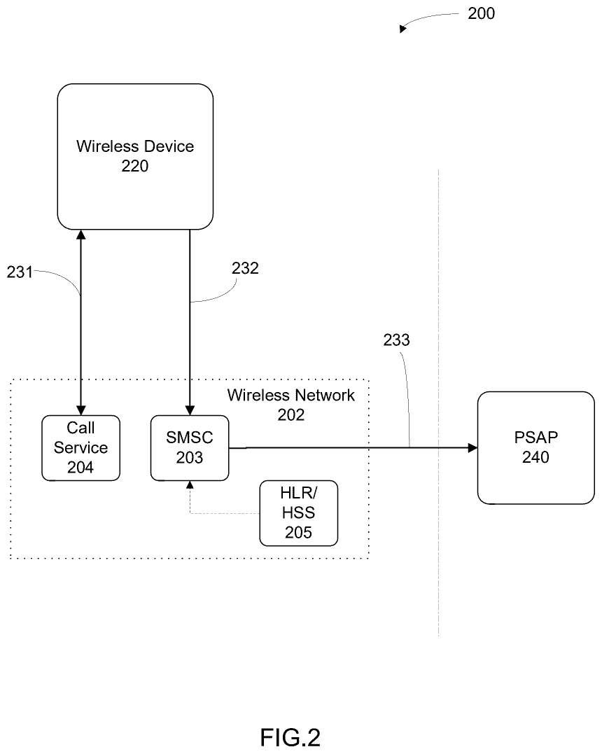

Now referring to FIG. 2, an exemplary system 200 for text message emergency communication is presented. System 200 includes a wireless device 220. Wireless device 220 may be the same as wireless device 120. System 200 also includes wireless network 202. Wireless network may include a RAN, core network and/or a communication network, which may be the same as, respectively, RAN 170, core network 102 and communication network 101. Wireless network 202 includes a call service 204. As used herein, the “call service” includes services and components used by a wireless network for handling voice transmission to emergency services. For example, call service 204 may include base transceiver station traffic channels (TCH) and control channels (CCH) used for transmitting. Wireless network 202 also includes SMSC 203, which may be the same as SMSC 103. As described in reference to FIG. 1, SMSC 203 is provided as an example and other components used for handling text messages may also be included, such as a MMSC. It should be noted that these descriptions are nonlimiting and are described within the context of what type of connection is being made for ease of description. For example, although a connection status such as a connection failure may be thrown by a base station controller, it will be described as being generated by call service 204. It should be noted that system 200 may be a part of, or the same as, system 100.

The system 200 also includes a public safety answering point (PSAP) 240. The PSAP may include any emergency answering service capable of receiving voice calls and text messages. Wireless Network 202 connects to PSAP 240 through communication link 233. PSAP 240 may be equipped with a Next Generation 911 (NG911) system capable of receiving text messages, video and data in a plurality of formats.

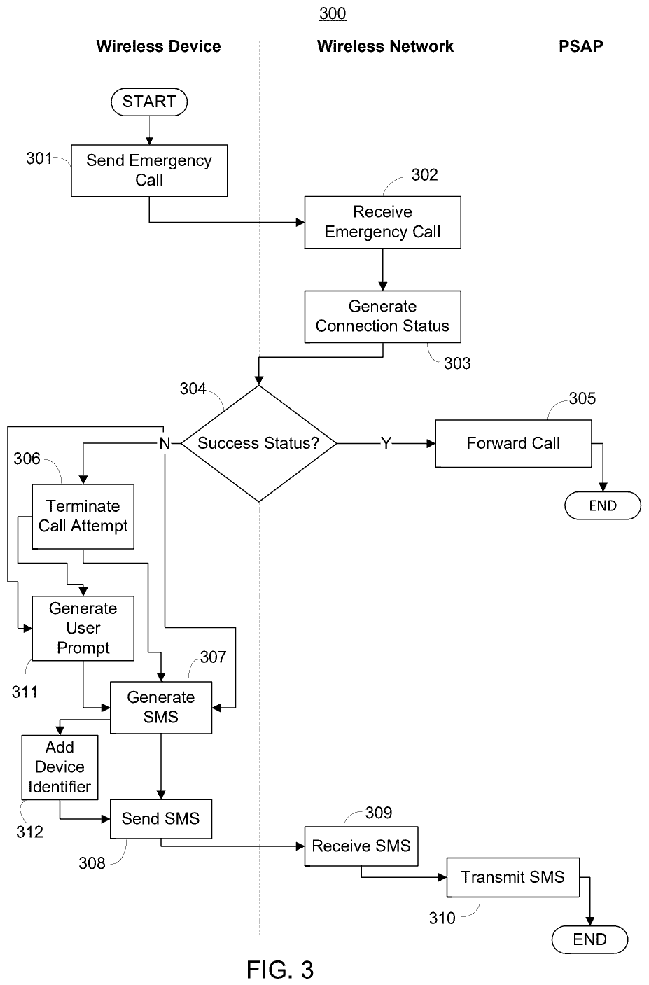

The wireless device 220 connects to call service 204 through communication link 231 and to SMSC 203 through communication link 232. As will be described in further detail in reference to FIG. 3, wireless device 220 sends a call request to PSAP 240 using call service 204. In normal circumstances, call service 204 transmits the call to the PSAP 240. In circumstances where the call cannot be completed, call service 204 returns a connection status with an error, or no response is returned, to wireless device 220. Wireless device 220 is configured to send an SMS message to SMSC 203, which transmits the SMS message to PSAP 240. The SMSC 203 will transmit an SMS message to PSAP 240 if no response is returned or if a connection error is returned by call service 204. In some embodiments, wireless network 202 may use a home location register (HLR) and/or home subscriber server (HSS) to get the information of the PSAP 240 needed to transmit the SMS message. Wireless network 202 may use the location of the cell being used by wireless device 220 to determine the correct PSAP to route the SMS. It is noted that the systems described herein are configured to send SMS messages when a call cannot be completed. As such, if the call is terminated by the user, or user device, the SMS message would not be sent to the PSAP 240.

Now referring to FIG. 3, an example decision flow 300 is presented. In this example, the flow begins at step 301, when the wireless device initiates an emergency call. For example, this step may be a call placed to 911. Once the wireless network receives the call request at step 302, the wireless network then generates a connection status, at step 303, which is sent to the wireless device.

At step 304, if the call status is successful, then the wireless network forwards the call to the PSAP, at step 305, and the flow ends. However, if the no successful status is generated, then the wireless device proceeds by generating a SMS message, at step 307. It should be noted that the SMS message may be generated based on an error notification, such as a call failed error, being generated by the wireless network, or if no response is returned to the wireless device. For example, the wireless device may determine that no response is being returned by the wireless network when no call status notification (e.g., call connected notifications, call failed error notifications, etc.) is returned by the wireless network within a predetermined timeout period. Such an error notification or lack of response may indicate that the connection status of the emergency call is termination by the wireless network. In some embodiments, the wireless device may also terminate the call attempt, at step 306. For example, the wireless device may terminate the call attempt based on an input to the wireless device to end the call. As described in reference to FIG. 2, the SMS message is only sent when a call to the PSAP cannot be completed, e.g., terminated by the wireless network. As such, if the call is terminated by the wireless device (i.e., by the user) the SMS message would not be generated and transmitted, and the flow would end. As described in reference to FIGS. 1 and 2, it should be noted that SMS message is used as an example, and other types of text messages could also be included in the decision flow.

In some embodiments, the wireless device may generate a user prompt, at step 311, prior to generating the SMS message. The user prompt is a prompt for the user to confirm sending the SMS message to PSAP. For example, the prompt may include a simple message asking if the user wants to send the message and a button to be clicked. As shown in the flow, the device identifier may be added to the SMS message before the prompt is generated. For example, the prompt may show the message to be sent, such as a message including the phone number for the device, which is displayed to the user to confirm the information is correct before sending to PSAP. After selection of the prompt at 311, the SMS message is generated at 307.

Continuing on the example flow, once the SMS is generated, the wireless device sends an SMS message, at step 308, to the wireless network. The wireless network receives the SMS message, at step 309, and then transmits the SMS message, at step 310, to the PSAP. In some embodiments, at step 312, the wireless device may add a device identifier to the SMS message. For example, the wireless device may add a Mobile Station International Subscriber Directory Number (MSISDN), e.g., phone number, and/or one or more other identifiers associated with the wireless device to the body of the message. In some examples, the wireless device may add the MSISDN and/or the one or more other identifiers to the header of the message.

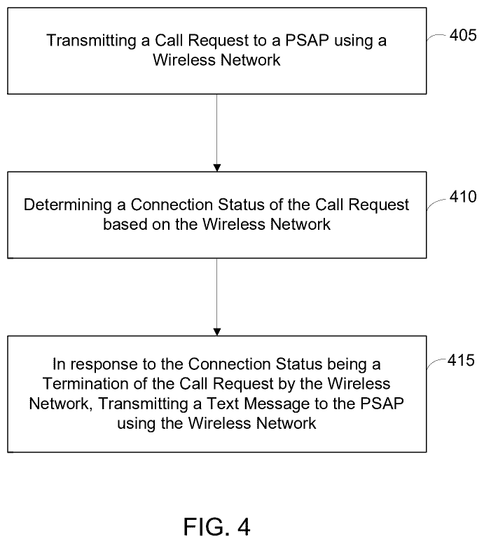

Now referring to FIG. 4, an example flow diagram of a method 400 for transmitting emergency text message is presented. At step 405, method 400 includes transmitting a call request to a PSAP using a wireless network, such as PSAP 240 and wireless network 202.

The method 400, at step 410, includes determining a connection status of the call request based on the wireless network. In embodiments, method 400 may further include determining that the connection status for a call request is termination by the wireless network. For example, the wireless device may determine that the connection status is termination by the wireless network after a timeout period is reached without a response from wireless network or upon receiving an error message from the network. In embodiments, the method 400 may include determining that the connection status of the call request is termination by the wireless device.

At step 415, method 400 includes, in response to the connection status being termination of the call request by the wireless network, transmitting an text message to the PSAP using the wireless network. In embodiments, method 400 may include generating the text message. In some embodiments, the text message may include an identifier for the wireless device. In further embodiments, the identifier may be a MSISDN associated with the wireless device. In embodiments, the text message may be an SMS message. In embodiments, method 400 may include transmitting the SMS message using an SMSC, such as described in reference to FIGS. 1 and 2.

In some embodiments, method 400 may include generating a user prompt. In embodiments, method 400 may further include transmitting the text message based on an interaction of a wireless device user with the user prompt. For example, a prompt may be shown to the user asking for confirmation, such as clicking a graphical user interface (GUI) button, before sending the text message.

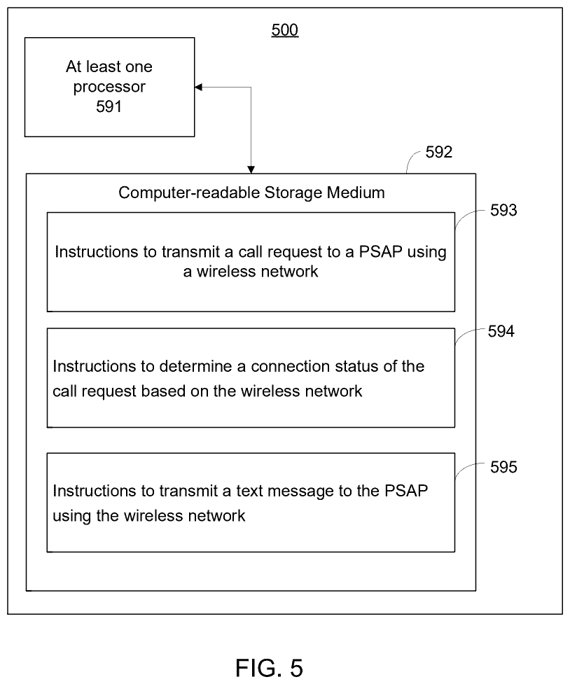

Now referring to FIG. 5, an example computing device 500 is presented. In this example, computing device 500 includes at least one processor 591 communicably coupled to a computer-readable storage medium 592. The at least one processor 591 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 592. In instances, at least one processor 591 may include electronic circuitry for performing instructions described in this disclosure.

In instances, computer-readable storage medium 592 may be any medium suitable for storing executable instructions. In examples, without limitation, computer-readable storage medium 592 may include RAM, ROM, EEPROM, HHD, SSD, optical disc, and the like. Computer-readable medium storage 592 may be disposed within computing device 500. In embodiments, computer-readable storage medium 592 may external, and communicably connected, to computing device 500. The instruction stored on computer-readable storage medium may be used to implement method steps described in reference to FIG. 4.

In this example, computer-readable storage medium 592 is encoded with set of instructions 593-595. In embodiments, executable instructions included in each block may be included in different blocks shown and blocks not shown.

Instruction 593, when executed by at least one processor 591, configures the at least one processor 591 to transmit a call request to a PSAP using a wireless network.

Instruction 594, when executed by at least one processor 591, configures the at least one processor 591 to determine a connection status based on the wireless network.

Instruction 595, when executed by at least one processor 591, configures the at least one processor 591 to, in response to the connection status being a termination of the call request by the wireless network, transmit a text message to the PSAP using the wireless network. For example, if the call cannot be completed, the connection status is determined to be unavailable and an SMS message is generated and transmitted via the network to a PSAP.

The computer-readable storage medium 592 may be further encoded with instructions, when executed by the at least one processor 591, configuring the at least a processor 591 to terminate the call request based on the connection status, generate the text message, where the text message includes an identifier for the wireless device, and generate a user prompt.

The computer-readable storage medium 592 may be further encoded with instructions, when executed by the at least one processor 591, configuring the at least a processor 591 to transmit the text message to the PSAP based on an interaction of a user with the user prompt. In an embodiment, at least one processor 591 is configured to receive the interaction between the user and the user prompt.

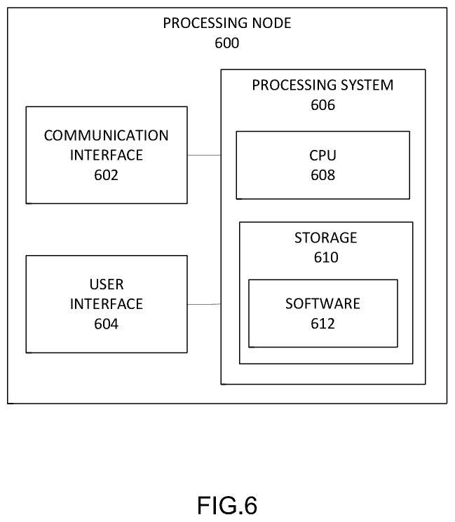

Now referring to FIG. 6, an example processing node 600, which may be configured to perform the methods and operations disclosed herein for selective attestation for emergency calls. The processing node 600 includes a communication interface 602, user interface 604, and processing system 606 in communication with communication interface 602 and user interface 604. Communication interface 602 may include hardware components, such as network communication ports, devices, routers, wires, antenna, transceivers, etc. User interface 604 may include hardware components, such as touch screens, buttons, displays, speakers, etc.

Processing system 606 includes a central processing unit (CPU) or processor 608, storage 610, which can comprise a disk drive, flash drive, memory circuitry, or other memory device including, for example, a buffer. Storage 610 can store software 612 which is used in the operation of the processing node 600. Software 612 may include computer programs, firmware, or some other form of machine-readable instructions, including an operating system, utilities, drivers, network interfaces, applications, or some other type of software. Processing system 606 may include a processor 608 and other circuitry to retrieve and execute software 612 from storage 610, which may be internal or external to the processing system 606. Processing node 600 may further include other components such as a power management unit, a control interface unit, etc., which are omitted for clarity. Communication interface 602 permits processing node 600 to communicate with other network elements. User interface 604 permits the configuration and control of the operation of processing node 600. Processing node 600 may be included in various elements of the wireless network including an access node, P-CSCF, E-CSCF, GMLC, STI-AS, SBC, or PSAP for example. In this example, software 612 may include the instructions described in reference to FIG. 5.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
transmitting, by a wireless device, a call request to a public safety answering point (PSAP) using a wireless network;
determining a connection status of the call request based on the wireless network; and
in response to the connection status being termination by the wireless network, transmitting a text message to the PSAP using the wireless network.

2. The method of claim 1, further comprising terminating the call request based on the connection status.

3. The method of claim 1, further comprising generating the text message.

4. The method of claim 3, wherein the text message comprises an identifier for the wireless device.

5. The method of claim 4, wherein the identifier for the wireless device includes a phone number for the wireless device.

6. The method of claim 1, the method further comprising generating a user prompt.

7. The method of claim 6, wherein transmitting the text message includes transmitting the text message based on an interaction of a user with the user prompt.

8. The method of claim 1, further comprising in response to the connection status being termination by the wireless device, refrain from transmitting the text message to the PSAP using the wireless network.

9. The method of claim 1, wherein the connection status is termination by the wireless network when there is no response from the wireless network or when an error is received from the wireless network.

10. The method of claim 9, wherein there is no response from the wireless network when no call status notification is received from the wireless network within a predetermined timeout period.

11. A system, the system comprising:
a wireless network;
a computing device communicatively connected to the wireless network, wherein the computing device comprises at least one processor configured to:
transmit a call request to a public safety answering point (PSAP) using the wireless network;
determine a connection status of the call request based on the wireless network; and
in response to the connection status being termination by the wireless network, transmit a text message to the PSAP using the wireless network.

12. The system of claim 11, wherein the computing device is further configured to in response to the connection status being termination by the computing device, refrain from transmit the text message to the PSAP using the wireless network.

13. The system of claim 11, wherein the computing device is configured to generate the text message.

14. The system of claim 13, wherein the text message comprises an identifier for the computing device.

15. The system of claim 14, wherein the identifier comprises a phone number associated with the computing device.

16. The system of claim 11, wherein the computing device is further configured to generate a user prompt.

17. The system of claim 16, wherein the transmit of the text message by the computing device is based on an interaction of a user with the user prompt.

18. A non-transitory computer-readable medium storing instructions, when executed by at least one processor, configuring the at least one processor to:
transmit a call request to a public safety answering point (PSAP) using a wireless network;
determine a connection status of the call request based on the wireless network; and
in response to the connection status being termination by the wireless network, transmit a text message to the PSAP using the wireless network.

19. The non-transitory computer-readable medium storing instructions of claim 18, wherein the at least one processor is further configured to:
generate the text message, wherein the text message comprises an identifier for a wireless device; and
generate a user prompt.

20. The non-transitory computer-readable medium storing instructions of claim 19, wherein the transmit includes transmit the text message to the PSAP based on an interaction of a user with a user prompt.
